(19) United States
(12) Patent Application Publication
(10) Pub. No.: US 2007/0067271 A1
(43) Pub. Date: Mar. 22, 2007

(54) Facilitating user interaction through cross-promotion of digital assets

(76) Inventor: Larry Lu, Great Falls, VA (US)

Correspondence Address: FISH & RICHARDSON P.C., P.O. BOX 1022, MINNEAPOLIS, MN, 55440-1022, US

(21) Appl. No.: 11/326,348

(22) Filed: Jan. 6, 2006

Related U.S. Application Data
(60) Provisional application No. 60/719,216, filed on Sep. 22, 2005.

(51) Int. Cl. G06F 17/30

(52) U.S. Cl. 707/3

(57) ABSTRACT

An online user may manage a personal digital library that includes digital assets. A user also may request content to be added to the user's digital library by entering a search string, and related parameters, into a user interface. Any information that matches the search request and currently exists, or is subsequently created, may automatically be added to the user's personal digital library. If the matching information exists as a digital asset in another user's digital library, the user seeking the information may gain access to the other user's digital assets. Communications between the two users may be encouraged in order to further share and exchange information on that topic or other related topics. An intermediary, such as a host operated by an online service provider, may be configured to generate social networks based on the personal digital libraries of the users.

### CROSS REFERENCE TO RELATED APPLICATION

This application claims priority to U.S. Provisional Application No. 60/719,216, filed Sep. 22, 2005 and titled “Facilitating User Interaction Through Cross-Promotion of Digital Assets,” which is incorporated by reference.

### TECHNICAL FIELD

This document relates to cross-promotion of digital assets.

### SUMMARY

In a first general aspect, a social network is established. A search request from a searching user is received. A digital asset library of at least one publishing user is accessed. A relationship between the search request and the digital asset library of the at least one publishing user is determined and based on the relationship, a social networking establishment metric is determined. The social networking establishment metric is compared to an establishment threshold and when the social networking establishment metric satisfies the establishment threshold, a social network is established.

With respect to at least the first general aspect, implementations may include one or more of the following. For example, after establishing the social network, an update to the digital asset library of the publishing user may be reviewed. When the update is responsive to a predicted interest of the searching user the searching user may be enabled to access the update.

Establishing the social network may include enabling access by the searching user to digital assets located within the digital asset library of the publishing user. The searching user may have a digital asset library. Enabling access by the searching user to the digital assets located within the digital asset library of the publishing user may include providing, in the digital asset library of the searching user, a link to the digital assets located within the digital asset library of the publishing user or a copy of the digital assets of the publishing user. An indication of the publishing user's identity may be received based on a determination made by the publishing user. The indication of the publishing user's identity may include the publishing user's identity, an alter ego identity of the publishing user, or an indication that the publishing user's identity is blocked. The indication of the publishing user's true identity may be received in response to the searching user's identity, where the searching user's identity may be a person directly known to the publishing user, a person indirectly known to the publishing user, a subscriber to an online service provider, a member of an organization, or a member of an age group. The indication of the publishing user's identity may be received in response to a grant by the publishing user of permission to indicate the publishing user's identity.

Enabling access by the searching user to digital assets located within the digital asset library of the publishing user may include sharing the digital assets and updates to the digital assets in the digital asset library of the publishing user between the searching user and the publishing user. Access to at least one of the digital assets, or updates to the digital assets, may be enabled if an indication of a number of digital assets is supported by a social network messaging threshold that indicates a maximum number of digital assets that may be shared during a period of time.

Determining a relationship between the search request and the digital asset library of the publishing user may include determining if the digital asset library of the publishing user includes digital assets having content responsive to the search request. It may be determined if the digital asset having content responsive to the search request is available for access by the searching user based on a permission level provided by the publishing user.

Receiving the search request may include receiving a search request for digital assets from a type of publishing user.

Determining a social networking establishment metric may include determining a number of publishing users that have digital assets having content responsive to the search request.

Comparing the social networking establishment metric to the establishment threshold may include establishing the social network with a threshold number of users.

The social networking establishment metric may include a first establishment metric. The search request may be adjusted in response to determining that the first establishment metric does not support establishing the social network. A relationship between the adjusted search request and the previously accessed digital asset library of the publishing user may be determined and a second establishment metric may be determined based on the relationship. The second establishment metric may be compared to the establishment threshold. When the second establishment metric satisfies the establishment threshold, the social network may be established.

Determining that the first establishment metric does not support establishing the social network may include indicating that the first establishment metric is greater than, or is less than, the establishment threshold. Determining that the second establishment metric satisfies the establishment threshold may include determining that the second establishment metric differs from the establishment threshold by an acceptable amount.

Adjusting the search request may include narrowing or broadening a scope of the search request. Adjusting the search request may include adjusting an amount of metadata or a type of metadata associated with the search request, where the metadata relates the search request to the digital asset library of the publishing user.

Adjusting the search request may include adjusting which digital asset libraries of multiple publishing users are compared with the search request based on types associated with the multiple publishing users. The types associated with at least one of the multiple publishing users may include a super-publishing user or an under-publishing user. The super-publishing user may be a publishing user who publishes a high quantity of high quality digital assets during a period of time. The under-publishing user may be a publishing user who publishes a low quantity of low quality digital assets during the period of time.

The social networking establishment metric may indicate a number of users having digital asset libraries that includes digital assets having content responsive to the search result. The establishment threshold may indicate a threshold amount of users that are appropriate to establish a social network. The social networking establishment metric may satisfy the establishment threshold when the number of users having digital asset libraries that include digital assets having content responsive to the search result is not more than an acceptable amount above or below the threshold amount of users that are appropriate to establish a social network.

In a second general aspect, A volume of messages in a first social network created for sharing access to digital assets among users is managed. A social networking messaging metric is determined. The social networking messaging metric is adjusted to support an amount of updates to the digital assets shared in the social network during a period of time. The social networking messaging metric is compared to a messaging threshold. When the social networking messaging metric does not satisfy the messaging threshold, a second social network for sharing access to digital assets and updates to the digital assets is created.

With respect to at least the second general aspect, implementations may include one or more of the following. For example, creating the second social network may include moving users from the first social network to the second social network such that the second social network may include a number of users and a number of digital assets and updates to the digital assets that is similar to the number of users, digital assets and updates to the digital assets that remain in the first social network. Creating the second social network may include moving users from the first social network to the second social network such that the second social network may include a quality of users and a quality of digital assets and updates to the digital assets that is similar to the quality of the users, digital assets and updates to the digital assets that remain in the first social network. The quality of a user may relate to the quantity of digital assets and updates to the digital assets published by the user and the quality of the content of the digital assets and updates to the digital assets published by the user. The quality of a digital asset and an update to a digital asset may relate to a responsiveness of the content of the digital asset and update to the digital asset to one or more topics of the social network.

Implementations of any of the techniques described may include a method or process, an apparatus or system, or computer software on a computer-accessible medium. The details of particular implementations are set forth below. Other features will be apparent from the description and drawings, and from the claims.

### DESCRIPTION OF DRAWINGS

FIG. 1 illustrates an exemplary graphical user interface (GUI) configured to enable an administrator to regulate establishment of social networks.

FIG. 2 illustrates an exemplary graphical user interface (GUI) for an actual configuration of a social network that has been established.

FIG. 3 illustrates an exemplary graphical user interface (GUI) inviting a user to join a social network.

FIG. 4 illustrates an exemplary graphical user interface (GUI) enabling a user to manage a library of digital assets.

FIG. 5 illustrates an exemplary graphical user interface (GUI) configured to encourage a recipient to access content published by another user.

FIG. 6 illustrates an exemplary graphical user interface (GUI) that may be presented to a recipient as a result of the recipient being designated as a “special” publisher.

FIG. 7 illustrates an exemplary graphical user interface (GUI) configured to inspire recipient participation in a social network.

FIG. 8 is a block diagram of an exemplary communications system where a host is configured to generate notifications for a client.

FIG. 9 is a flow chart of an exemplary process by which social networks are fostered between a searching user and a publishing user.

FIG. 10 is a flow chart of one detailed implementation of operations described with respect to FIG. 9.

FIG. 11 illustrates an exemplary graphical user interface (GUI) that may be presented to a user as a user visits one or more web pages.

### DETAILED DESCRIPTION

The growth of communications networks, such as the Internet, enables an online user to manage a personal digital library with photos, emails, documents, weblogs, and opinions. For example, a user may write a review of a new novel and store that review in the user's digital library.

Just as a user “owns” content in the library of digital assets, so too may a user request content. For example, if a user seeks information on a particular topic, the user may enter a search string into a user interface. The user also may enter various parameters to seek the information in a more precise manner. For example, a user may seek to buy a used boat from a seller in the same geographic location as the user. In this case, the user can enter “boat for sale” as his search string, along with other parameters, such as the user's location, the user's preference for a private seller (rather than a boat dealer), boat size, features, and price range. Once the search information is entered, any matching information that currently exists or is subsequently created may automatically be added to the user's personal digital library as an advertising document, for example.

When a user seeks information on a particular topic that exists in another user's digital library, the user seeking the information may gain access to the information even though it exists in another user's digital assets. In addition, communications between the two users may be encouraged in order to further share and exchange information on that topic, as well as to engage in personal interaction (e.g., instant messaging or e-mail communications) in conjunction with the sharing of information. This allows the user seeking the information to receive information that currently exists, as well as information that will be updated or created in the future.

To encourage and facilitate such sharing of information and personal interaction between users, an intermediary, such as a host operated by an online service provider, may be configured to generate social networks based on the personal digital libraries of the users. More precisely, a social network may be used in order to “foster” exchange of information between users so that, for example, a first user may access content in a second user's library. As a result of fostering communications between different users using social networks, the value and trustworthiness of content residing in the library of personal digital assets may be increased, particularly when a user seeks word-of-mouth information. For example, some users may prefer content created by “average” users over content published by accredited news organizations and other media properties, out of concern that the latter form of information may be slanted by public relations firms or sponsors.

In an advanced implementation, a social networking system may be configured to maintain communications in an optimal range. Above the “high” threshold, a user loses interest due to the vast amount of information to wade through. Below the “low” threshold, a user loses interest due to too little valuable information. In response to this problem, social networks may be configured to foster an ideal amount of messaging.

When the user's request is too narrow, the search may be broadened. Similarly, the amount or type of information received may be narrowed when the user's request is too broad. Thus, if the user specifies a search string that is too narrow, the user may, at the user's option, receive information messages related to similar, but broader topics. Alternatively, if the search string specified by the user is too broad, the user may, at the user's option, automatically receive no more messages than the threshold amount. The number of messages in this case also may be limited by restricting the messages received to certain creators, creators in certain locations, or creators who receive positive or trustworthy feedback on their information. If a social network becomes too large, the social network may be apportioned into smaller social networks.

A user also may grant permission over access to information the user creates. Once the user has created a digital asset, a tag can be added to the information to indicate who may receive, or access, the information in response to an information search. There are several categories of people who the user can specify to receive the information. These categories may include others who are known to the creating user, others who are within a certain degree of others who are known to the user (e.g., friends of friends), others who have subscribed to a particular service (e.g., only AOL users), all others, or no others. The user also may choose to be anonymous when the information is received by all users, or only a sub-set of users, eligible to receive the information. For example, the user may choose to block the user's identity such that other users may not receive any indication of the user's identity or may receive an indication that the user's identity is blocked.

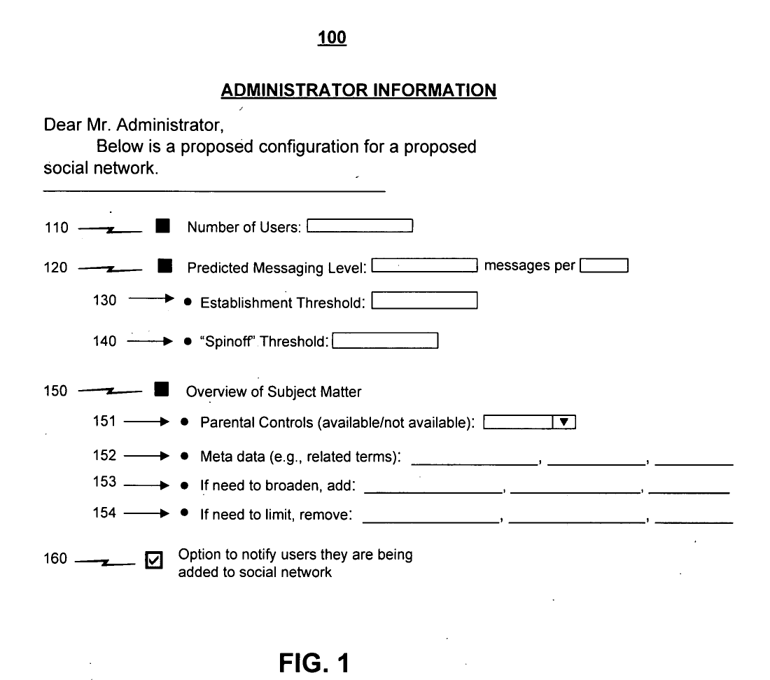

FIG. 1 illustrates an exemplary graphical user interface (GUI) 100 configured to enable an administrator to regulate establishment of social networks. As shown, GUI 100 illustrates that the exemplary configuration for a social network reflects the number of users 110, a predicted messaging level 120 (e.g., 20 messages per day), an establishment threshold 130 (e.g., 1000 users, 50 messages/day and/or a hybrid, normalized value that reflects more than one factor), and a spin-off threshold 140 (e.g., a social network establishment threshold indicative of a point at which a social network should be reconfigured into multiple groups). GUI 100 also includes an overview of the subject matter of the social network 150, such as an indication of whether the subject matter is appropriate for regulation by parental control systems 151, a list of metadata used to describe the subject matter 152, and a list of metadata that may be used to broaden 153 or limit 154 the size and/or activity within the social network. In addition, GUI 100 includes an option 160 enabling an administrator to notify users when they are being added to a social network.

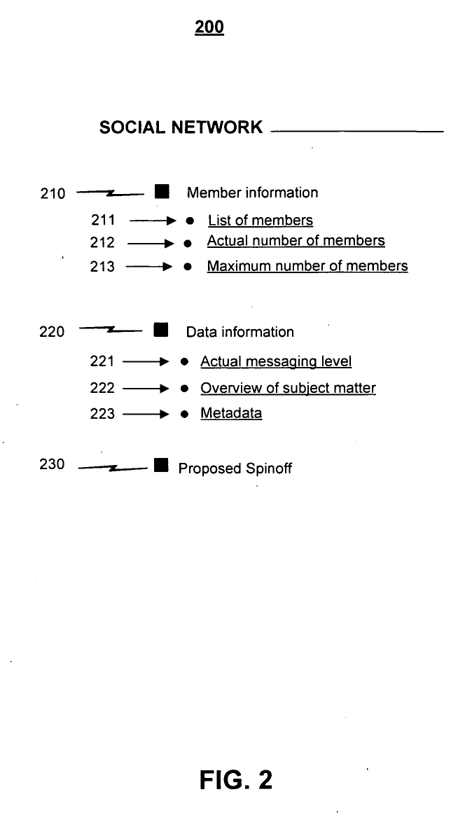

FIG. 2 illustrates an exemplary GUI 200 that illustrates an actual configuration of a social network that has been established. For example, a configuration for a social network may include member information 210. Member information 210 reflects a list of members 211, an actual number of members 212, and a maximum number of members 213. The configuration may also include data information 220. Data information 220 may include an actual messaging level 221, an overview of subject matter 222, and a list of metadata 223. A proposed spin-off 224 indicating how a social network may be further divided or sub-divided into two or more groups may also be included in GUI 200.

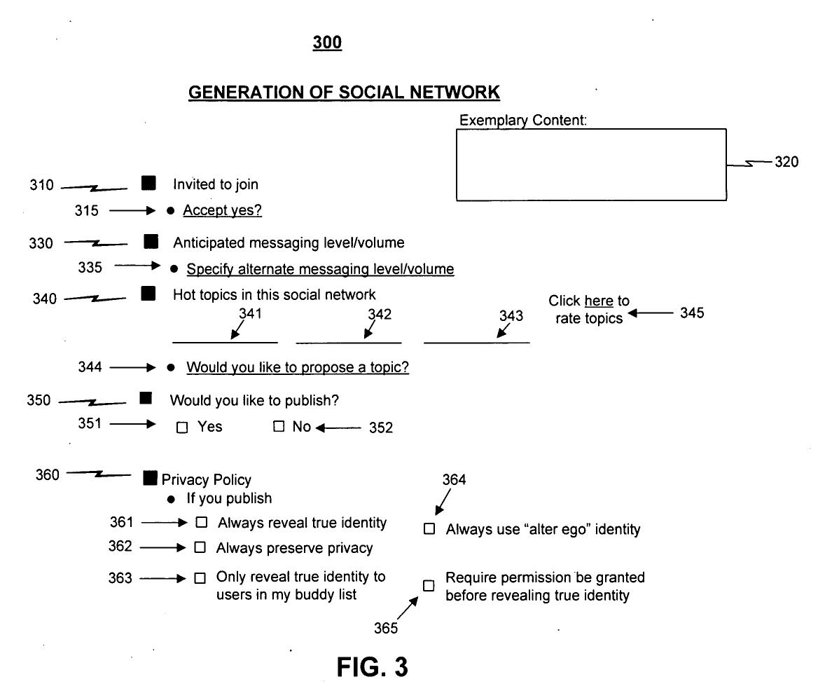

FIG. 3 illustrates an exemplary GUI 300 inviting a user to join a social network. As shown, GUI 300 includes an “accept” link 315 enabling a user to join a social network that the user has been invited to join 310. GUI 300 also includes an indication of exemplary content 320 a user may receive if the user elects to join the social network. An anticipated messaging level 330 and a control 335 enabling the user to specify an alternate messaging level may also be included. The GUI also includes an indication of hot topics in the social network 340 (e.g., an expression of a degree of interest in one or more areas of subject matter), includes particular hot topics 341-343. The hot topics section of GUI 300 also may include an input control 344 enabling a user to propose additional topics and a rating control 345 enabling a user to rate one or more topics. A publication control 350 enables a user to specify whether content in the user's digital asset library should be published by selecting one of check boxes 351, to indicate that the user's content should be published, or 352, to indicate that the user's content should not be published. GUI 300 also includes a privacy policy control 360 enabling the user to selectively reveal their true identity and/or an “alter ego” identity (e.g., an identity that cannot be traced back to the user's true identity). More particularly, a user may select one of check boxes 361-365 to always reveal the user's true identity 361, always preserve the user's privacy 362, only reveal the user's true identity to others in the user's buddy list 363, always reveal the user's “alter ego” identity 364, or require permission before revealing the user's true identity 365.

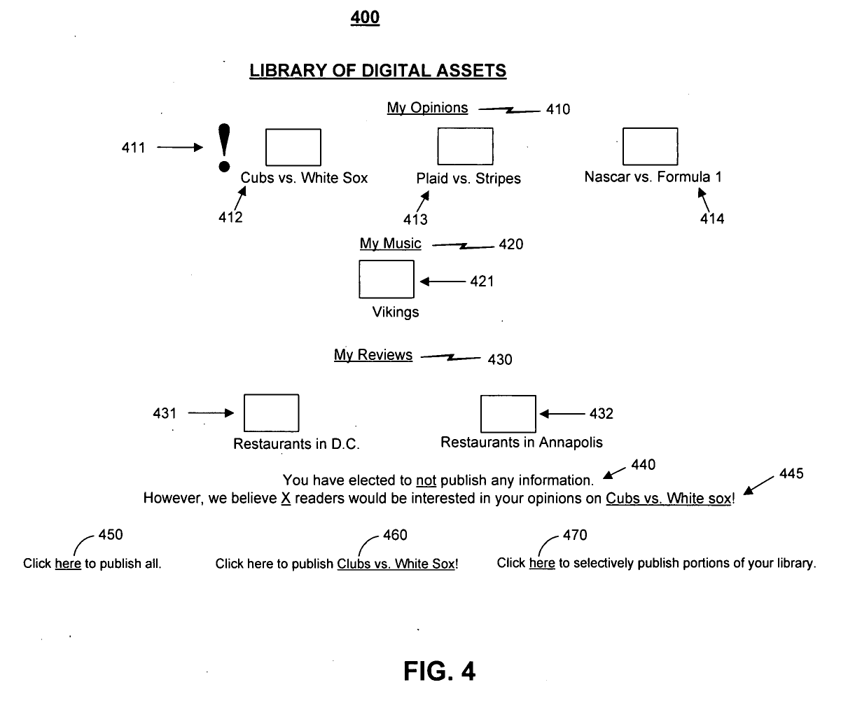

FIG. 4 illustrates an exemplary GUI 400 enabling a user to manage a library of digital assets. As shown, the library includes “My Opinions” 410 addressing the topic of “Cubs vs. White Sox” 412, “Plaid vs. Stripes” 413, and “NASCAR v. Formula 1” 414. “My Music” 420 includes content relating to the user's own band (e.g., the “Vikings”) 421. “My Reviews” 430 includes a review of restaurants in D.C. 431 and Annapolis 432.

GUI 400 includes a message 440 indicating that the user has not elected to publish any information. GUI 400 also includes a message 445 indicating that X number of readers are believed to be interested in the user's opinions on “Cubs vs. White Sox”. Expression of the interest in “Cubs vs. White Sox” is graphically represented in the exclamation icon 411 next to the “Cubs vs. White Sox” label. Finally, GUI 400 includes buttons enabling the user to publish all content 450, publish “Cubs vs. White Sox” 460, and/or selectively publish portions of the user's library 470.

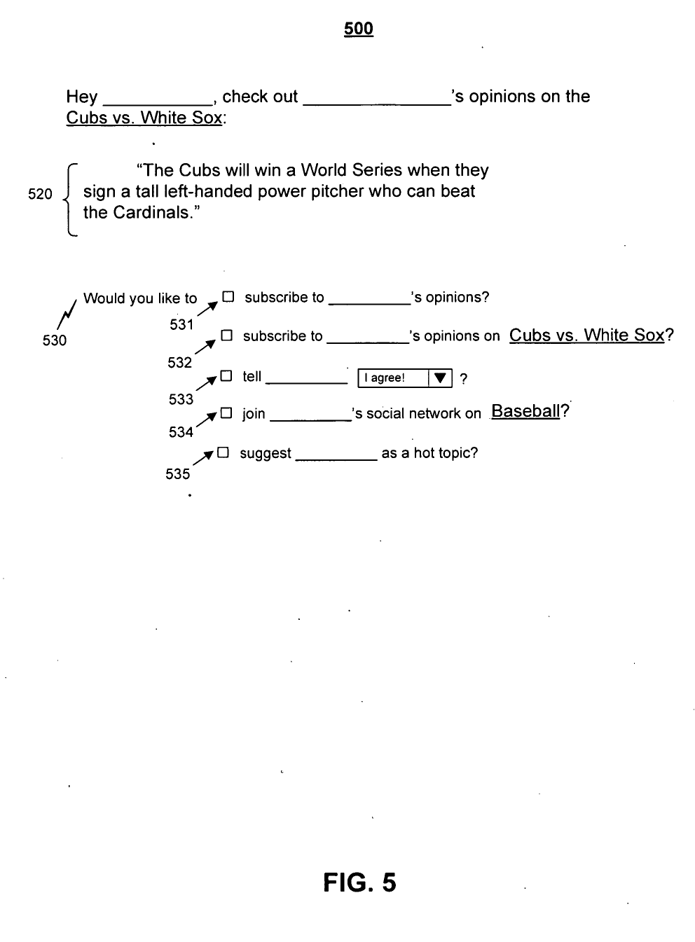

FIG. 5 illustrates an exemplary GUI 500 configured to encourage a recipient to access content published by another user. As shown, GUI 500 includes a personalized greeting 510 encouraging the recipient to access a particular user's opinions on “Cubs vs. White Sox”. GUI 500 also includes a synopsis of the publishing user's opinion 520 (e.g., “The Cubs will win a World Series when they sign a tall left-handed power pitcher who can beat the Cardinals”).

GUI 500 enables the recipient to select from a variety of options 530. The user may subscribe to the publishing user's opinions 531, subscribe to the publishing user's opinions on a particular topic 532 (e.g., “Cubs vs. White Sox”), send a message to the publishing user 533 (e.g., “I agree”), join a proposed social network 534 (e.g., baseball), and/or suggest a particular subject as a “hot topic” 535.

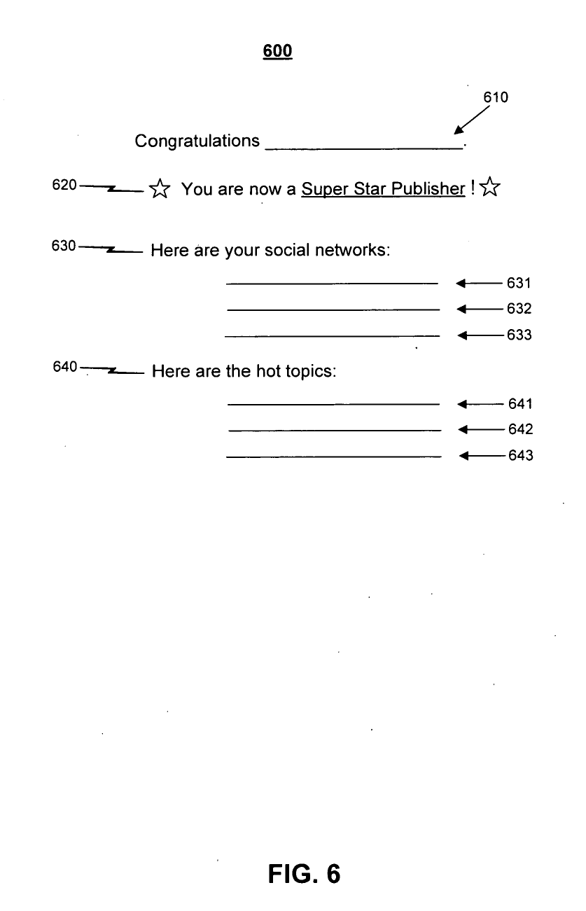

FIG. 6 illustrates an exemplary GUI 600 that may be presented to a recipient as a result of the recipient being designated as a “special” publisher. As shown, GUI 600 includes a personalized greeting 610 indicating that the recipient has been designated as a “Super Star Publisher” 620. The “special” status may be based on the quality and/or volume of participation. Receiving “special” status may selectively enable access to premium content, prioritize publication of content over non-special users, promote distribution in multiple social networks, and/or simply to provide encouragement. GUI 600 indicates the social networks to which the recipient belongs 630, including social networks 631-633, and the hot topics in one or more of the social networks 640, including hot topics 641-643.

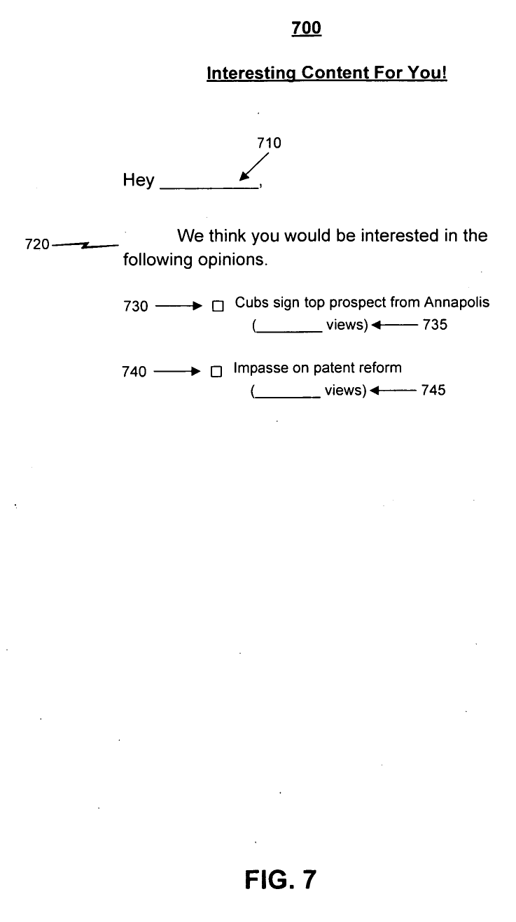

FIG. 7 illustrates an exemplary GUI 700 configured to inspire recipient participation in a social network. As shown, GUI 700 includes a personalized greeting 710 for a message suggesting that the recipient would be interested 720 in two proposed topics 730 and 740. One proposed topic 730 that has already been viewed a specified number of times 735 relates to the Cubs signing a top prospect from Annapolis. The second proposed topic 740, viewed a different number of times 745, relates to an impasse on patent reform. Messages such as GUI 700 may be delivered to one or more users to encourage greater interaction within a social network. By promoting greater interaction within a social network, the quantity and quality of the content may increase, thereby assisting members within the social network. Furthermore, the value of relevant advertisements may be increased as the value of the social network increases.

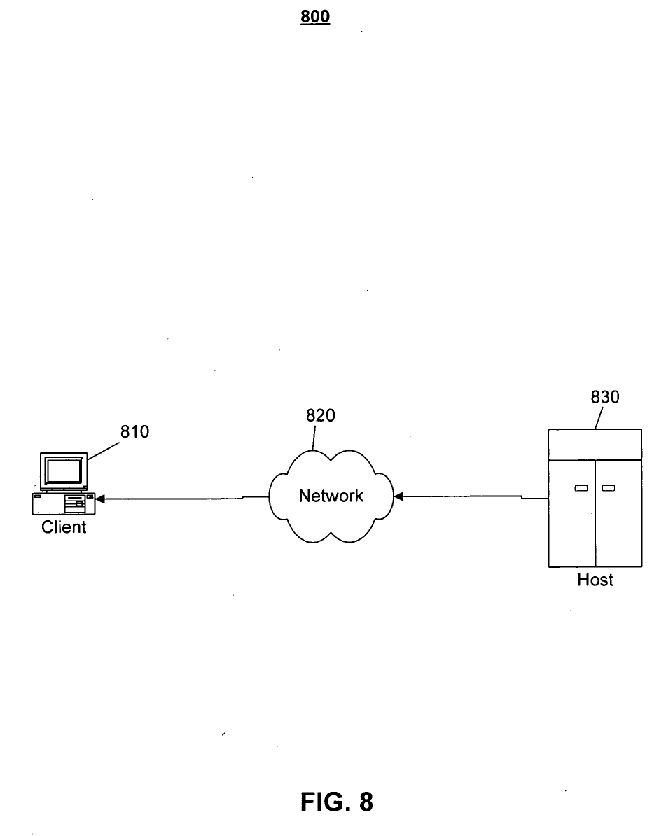

FIG. 8 is a block diagram of an exemplary communications system 800 where a host 830 is configured to generate notifications for a client 810. Generally, the client 810 displays one or more GUIs (e.g., the GUIs described previously with respect to FIGS. 1-7) to manage and participate in the social networks described previously.

Each of the client 810 and the host 830 may be implemented by, for example, a general-purpose computer capable of responding to and executing instructions in a defined manner, a personal computer, a special-purpose computer, a workstation, a server, a device, a component, other equipment or some combination thereof capable of responding to and executing instructions. The client 810 and host 830 may be configured to receive instructions from, for example, a software application, a program, a piece of code, a device, a computer, a computer system, or a combination thereof, which independently or collectively direct operations such as those described in this document. The instructions may be embodied permanently or temporarily in any type of machine, component, equipment, storage medium, or propagated signal that is capable of being delivered to the client 810 or the host 830.

The client 810 may include one or more devices capable of accessing content on the host 830. The host 830 may include a general-purpose computer (e.g., a personal computer (PC)) capable of responding to and executing instructions in a defined manner, a workstation, a notebook computer, a PDA (“Personal Digital Assistant”), a wireless phone, a component, other equipment, or some combination of these items that is capable of responding to and executing instructions.

In one implementation, the client 810 includes one or more information retrieval software applications (e.g., a browser, a mail application, an instant messaging client, an Internet service provider client, a media player, or an AOL TV or other integrated client) capable of receiving one or more data units. The information retrieval applications may run on a general-purpose operating system and a hardware platform that includes a general-purpose processor and specialized hardware for graphics, communications and/or other capabilities. In another implementation, the client 810 may include a wireless telephone running a micro-browser application on a reduced operating system with general purpose and specialized hardware capable of operating in mobile environments.

The client 810 may include one or more media applications. For example, the client 810 may include a software application that enables the client 810 to receive and display an audio or video data stream. The media applications may include controls that enable a user to configure the user's media environment. For example, if the media application is receiving an Internet radio station, the media application may include controls that enable the user to select an Internet radio station, for example, through the use of “preset” icons indicating the station genre (e.g., country) or a favorite. In another example, the controls may enable the user to rewind or fast-forward a received media stream. For example, if a user does not care for a track on a particular station, the user may interface with a “next track” control that will queue up another track (e.g., another song).

The network 820 includes hardware and/or software capable of enabling direct or indirect communications between the client 810 and the host 830. As such, the network 820 may include a direct link between the client 810 and the host 830, or it may include one or more networks or sub-networks between them (not shown). Each network or sub-network may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

The host 830 may include and/or form part of an information delivery network, such as, for example, the Internet, the World Wide Web, an online service provider, and/or any other analog or digital wired and/or wireless network that provides information. Such information delivery networks may support a variety of online services, including Internet and/or web access, e-mail, instant messaging, paging, chat, interest groups, audio and/or video streaming, and/or directory services.

In one implementation, the host 830 includes one or more information-providing software applications for accessing and transmitting requested files to the client 810. The information-providing applications may run on a general-purpose operating system and a hardware platform that includes a general-purpose processor and/or specialized hardware. Another implementation may include a reduced operating system with both general purpose and specialized hardware to operate in mobile environments.

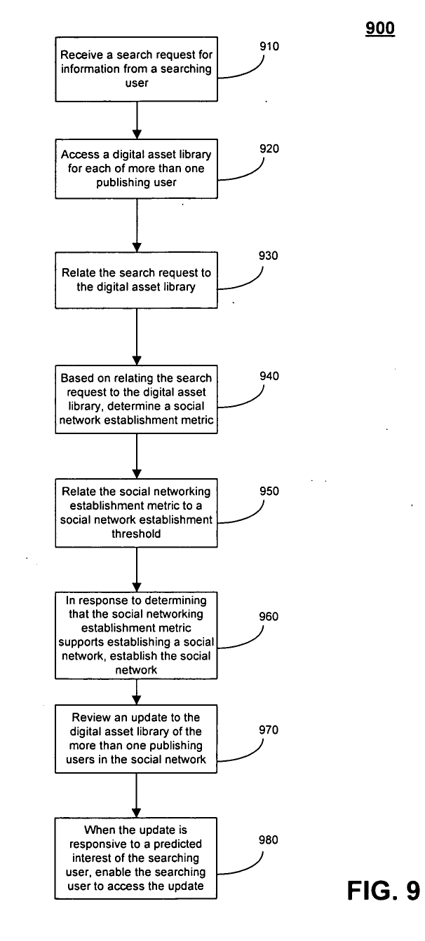

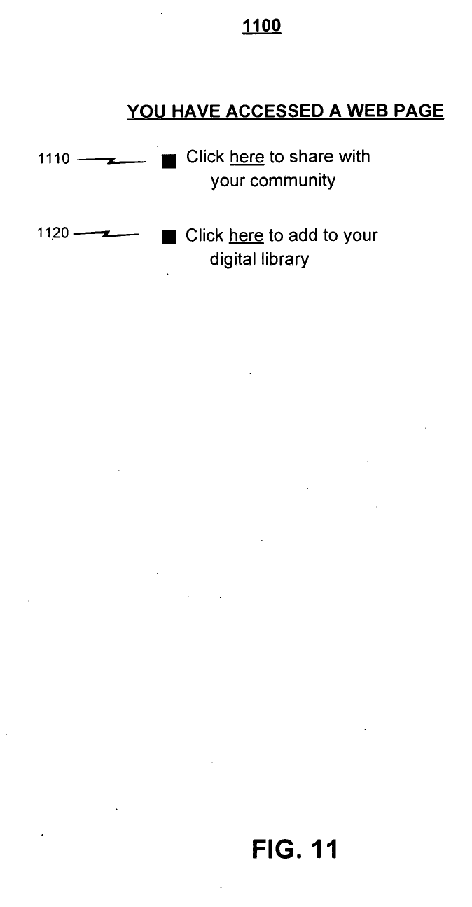

FIG. 9 is a flow chart 900 of an exemplary process by which social networks are fostered between a searching user and a publishing user. Generally, the operations shown in flow chart 900 may be used in conjunction with the systems and configurations described above with respect to FIGS. 1-7 and described below with respect to FIG. 11. For example, a user may implement the operations shown in flow chart 900 by using the UIs shown in FIGS. 1-7 and 11. Similarly, the systems used in flow chart 900 may use the underlying systems and componentry described with respect to FIG. 8. For convenience, particular components described earlier are referenced as performing the process. However, similar methodologies may be applied in other implementations where different components are used to define the structure of the system, or where the functionality is distributed differently among the components shown.

Initially, host 830 receives a search request for information from a searching user (910). Host 830 then accesses a digital asset library for more than one publishing user who has published information in the publishing user's digital asset library (920). The search request is then related, or compared, to the contents of the digital asset library of the more than one publishing users (930).

Next, based on the comparison between the search request and the content of the digital asset library of each of the more than one publishing users, host 830 determines a social networking establishment metric (940). Host 830 then relates, or compares, the social networking establishment metric to a social network establishment threshold (950). If the comparison between the social networking establishment metric and the social network establishment threshold supports establishing a social network, host 830 establishes the social network (960).

After the social network is created, a publishing user in the social network may update the publishing user's digital asset library. Once an update to the digital asset library of at least one of the publishing users in the social network is identified, host 830 reviews the update (970). If the update is responsive to a predicted interest of the searching user (e.g., if the update is responsive to the searching user's original search or a related search), host 830 enables the searching user to access the update (980).

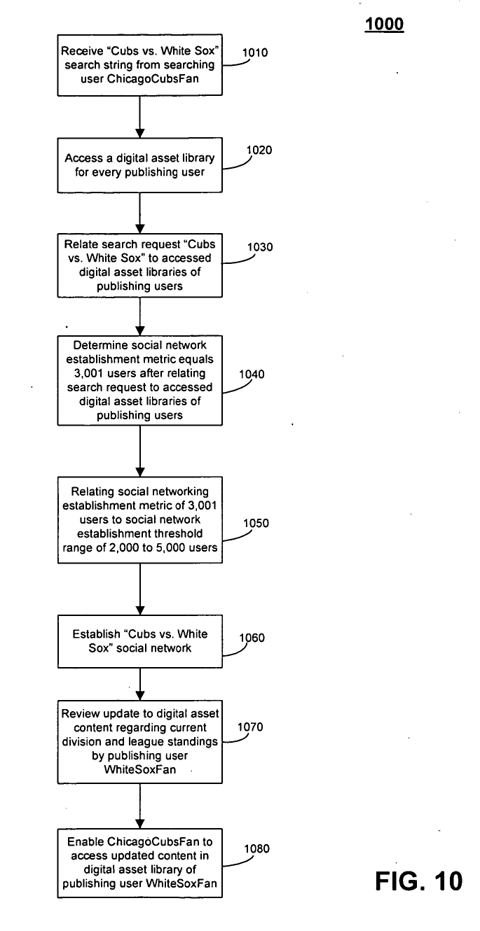

FIG. 10 is a flow chart 1000 of one detailed implementation of operations described with respect to FIG. 9. In particular, flow chart 1000 illustrates an exemplary process by which social networks may be fostered between a searching user and a publishing user. Generally, the operations shown in flow chart 1000 may be used in conjunction with the systems and configurations described above in FIGS. 1-7 and described below in FIG. 1 1. For example, a user may implement the operations shown in flow chart 1000 by using the UIs shown in FIGS. 1-7 and 11. Similarly, the systems used in flow chart 1000 may use the underlying systems and componentry described with respect to FIG. 8. For convenience, particular components described earlier are referenced as performing the process. However, similar methodologies may be applied in other implementations where different components are used to define the structure of the system, or where the functionality is distributed differently among the components shown.

Initially, host 830 receives a search request from searching user ChicagoCubsFan for information relating to “Cubs vs. White Sox” (1010). Host 830 then accesses a digital asset library of one or more publishing users (1020). For example, within a community of 10,000 users, some users may maintain an individual digital asset library (e.g., emails, documents, photos, weblogs, or opinions) and may publish information to varying degrees. Host 830 references the digital asset library of at least some of the users in order to facilitate user interaction through cross-promotion of digital assets within the digital asset library.

Host 830 then relates (e.g., compares) the searching user's request for “Cubs vs. White Sox” to the digital asset libraries of the publishing users identified in operation 1020 (1030). In other words, host 830 searches the digital asset libraries of the publishing users to determine if the digital asset libraries include content relevant to the information desired by ChicagoCubsFan regarding “Cubs vs. White Sox.”

Once host 830 determines that there is some degree of relation between the information requested and the digital asset libraries of the publishing users, a social network establishment metric is determined (1040). For example, content in digital asset libraries of 3,000 of 10,000 publishing users may include content related to “Cubs vs. White Sox.” In another example, multiple digital asset libraries may reference “Cubs vs. White Sox” metadata (e.g., Mark Prior, Ozzie Guillen) a threshold number of times.

The social network establishment metric may be used in determining whether generating a social network related to a particular subject matter or interest, or around a specific criterion (e.g., location) is responsive to the predicted interest of a community of users. For example, the social network establishment metric may be used in determining whether criteria specified by searching user ChicagoCubsFan and other likeminded users represents a sufficient community able to support desire for information expressed by proposed members of the community. In one implementation, the social network establishment metric may include a total number of publishing users having content in the digital asset library related to the searching user's desired information added to the number of specific searching users identified (e.g., ChicagoCubsFan). In another implementation, the social network establishment metric may relate to a total number of publishing users having content in the digital asset library related to the searching user's desired information, which may be modified to reflect the number of searching users and/or the degree of interest in the particular content. In one implementation, the social network establishment metric relates to a time-frame and/or a geographic area.

In still another implementation, the social network establishment metric may reflect an amount of information distributed across a number of digital asset libraries of the more than one publishing users accessed in operation 1020 that is relevant to the searching user's desired information. For the current example, assuming the social network establishment metric for the information desired by ChicagoCubsFan represents 3,000 publishing users having relevant content in individual digital asset libraries, the number 3,000 may be added to the ten searching users expressing interest in similar subject matter to ChicagoCubsFan. Thus, the social network establishment metric is 3,010.

Once the social network establishment metric is determined by host 830, it is related, or compared, to a social network establishment threshold (1050). The social network establishment threshold may reflect a range (e.g., a high and low value) outside of which establishing a social network is not deemed useful due to a volume of information that is either too small or too large. For example, the social network establishment threshold may include a low value of 2,000 users and a high value of 5,000 users. Therefore, in the current example, during operation 1050, host 830 compares the social network establishment metric of 3,010 users with the social network establishment threshold of 2,000 to 5,000 users to determine if creating a social network would be useful in this case. Because the social network establishment metric falls within the social network establishment threshold range, host 830 determine the social network establishment metric supports establishing a social network. In another implementation, the social network establishment metric and/or social network establishment threshold reflects an anticipated volume of messages exchanged.

If the social network establishment metric is not supported by the social network establishment threshold range, the searching user's desired information may be broadened or narrowed to create a social network establishment metric that does support establishing a social network. For example, if only 1,500 publishing users have content in the digital asset libraries relating to “Cubs vs. White Sox,” host 830 may search for digital asset libraries containing related information, such as “Chicago Baseball,” “Midwest Baseball,” or an even broader “Major League Baseball.” Similarly, if host 830 determines that 50,000 publishing users have content in the digital asset libraries relating to “Cubs vs. White Sox,” host 830 may search for a narrower version of the desired information, such as a comparison of pitchers “Greg Maddox vs. Brandon McCarthy” or catchers “Michael Barrett vs. Raul Casanova.” By changing the scope of the desired information, the social network establishment metric also may be adjusted in response to the social network establishment threshold range with the goal of establishing a social network where the social network otherwise would not be established.

In some implementations, rather than changing the scope of the desired information to ensure that the social network establishment metric will support establishing the social network, the social network establishment threshold may be adjusted to ensure that the social network is established. For example, if 1,500 publishing users have content related to “Cubs vs. White Sox,” rather than broadening the scope of the user's desired information to include related topics such as “Chicago Baseball,” the social network establishment threshold may be reduced from a range of 2,000 to 5,000 to a range of 1,000 to 5,000. Similarly, the social network establishment threshold may be increased from a range of 2,000 to 5,000 to a range of 2,000 to 100,000 rather than narrowing the scope of the user's desired information to achieve a social network establishment metric that supports establishing the social network.

Host 830 then establishes a “Cubs vs. White Sox” social network (1060) that includes the searching the digital asset libraries of user ChicagoCubsFan and each publishing user having content in the digital asset library relevant to “Cubs vs. White Sox.”

Once the “Cubs vs. White Sox” social network is created, a publishing user may update the content of that publishing user's digital asset library relating to the original information desired by searching user ChicagoCubsFan. When host 830 detects an update to content relevant to “Cubs vs. White Sox” in the digital asset library of a publishing user, host 830 reviews the update to determine if the updated content is responsive to a predicted interest of the searching user (1070). In other words, host 830 reviews the update to determine if the updated content is responsive (e.g., identical or similar) to the searching user's original desired information (1070). For example, if publishing user WhiteSoxFan updates his weblog to compare the current standings of the Chicago White Sox and the Chicago Cubs in their leagues and divisions, or adds new photos of himself with each of the teams' star pitchers, or includes an email from his brother commenting on his road trip to see both the White Sox and the Cubs in away games, the updated information may be deemed responsive to the original information desired by searching user ChicagoCubsFan.

Once host 830 determines the information updated by publishing user WhiteSoxFan is responsive to a predicted interest of searching user ChicagoCubsFan, host 830 enables searching user ChicagoCubsFan to access the updated information. In one implementation, the updated information may automatically be delivered from the publishing user's digital asset library to the searching user's digital asset library. In another implementation, the searching user may receive a link to the updated information in the publishing user's digital asset library. In yet another implementation, the searching user may receive a notification to determine if the searching user is interested in receiving the publishing user's updated information either directly to the searching user's digital asset library or via a link to the publishing user's digital asset library.

Although two users both may be members of the “Cubs vs. White Sox” social network, the social network that each user belongs to may differ by at least one person. For example, if the majority of information sought by ChicagoCubsFan is related to Chicago pitchers, the social network that ChicagoCubsFan is a member of may include other users who are interested in Cubs vs. White Sox with an emphasis on pitchers. In another example, WhiteSoxFan may prefer to receive information related to ticket sales for home games, but may not care too much about specific pitchers for either team. As such, WhiteSoxFan may belong to a social network for Cubs vs. White Sox with an emphasis on home games and ticket sales. Additionally, even if WhiteSoxFan and ChicagoCubsFan are members of the same “Cubs vs. White Sox” social network, the “Cubs vs. White Sox” social network may be one of many social networks to which each user belongs. In this case, it is likely that membership in social networks may vary greatly from user to user (e.g., it is unlikely that two users will belong to exactly the same social networks, although it is possible). For example, WhiteSoxFan also may be a member of a “Yoga” social network, while ChicagoCubsFan may be a member of the “Bon Jovi” social network, in addition to their membership in the “Cubs vs. White Sox” social network.

After a social network is established, the number of digital assets, publishing users, related topics, messaging volume, or any other metric related to the size of a social network, may exceed the social network establishment threshold used in determining whether to establish the social network in the first instance. In this case, a spin-off social network may be established to accommodate the excess. For example, if the number of publishing users having content in the users' digital asset libraries related to “Cubs vs. White Sox” exceeds the social network establishment threshold maximum of 5,000 in the previous example, the publishing users in excess of 5,000 may be invited to join, or automatically made members of, the spin-off “Cubs vs. White Sox 2” social network. The spin-off social network may not be established until the number of excess publishing users exceeds the social network establishment threshold minimum, which in this example is 1,000. Alternatively, another metric may be used to determine when to establish a spin-off social network. For example, when the number of publishing users exceeds the social network establishment threshold maximum, a spin-off social network may be established such that half of the publishing users are members of each of the original and spin-off social networks.

A spin-off social network also may be established to include publishing users having content related to sub-topics of the topics included in the original social network. For example, if a large number of publishing users are found to have content related to Chicago pitchers, a “Chicago Pitchers” spin-off social network may be established to include those publishing users. In some implementations, users may be a member of both the “Cubs vs. White Sox” social network and the “Chicago Pitchers” spin-off. In other implementations, users may simply be a member of the “Chicago Pitchers” spin-off social network, which also may include Cubs vs. White Sox content.

Publishing users may be included in a spin-off social network based on a type associated with each publishing user. A publishing user type may be related to demographic information, such as age or geographic location, or a level of participation in the social network. For example, all publishing users of a certain age range may be moved from the original “Cubs vs. White Sox” social network to a new “Young Cubs vs. White Sox” spin-off social network. In another example, the current, or projected, volume of digital assets contributed by particular publishing users may be taken into account to move some very high volume (or high quality) publishing users (e.g., super-publishers) and some very low volume publishing users (e.g., under-publishers) to a new spin-off social network to ensure that the original social network is not more or less stocked with content than the spin-off social network.

FIG. 11 illustrates an exemplary GUI 1100 that may be presented to a user as a user visits one or more web pages. For example, GUI 1100 may be linked to a web browser. As the user visits a web page (e.g., cnn.com), the user may select controls 1110 and/or 1120 shown in GUI 1100 in order to share a web page with their social network 1110 (e.g., “Click Here to share with your community”) and/or add the web page to a digital library 1120. Depending on the criteria in effect for the user's library of digital assets and/or publication rules for a particular social network, adding the web page to a digital library still may distribute the web page to a social network as the web page is evaluated.

Other implementations are within the scope of the following claims. For example, although various operations were described as being performed on a host, the operations also may be performed on a client and/or in a distributed manner. Similarly, although some of the operations were described as being performed with respect to a searching user and/or a publishing user, the operations also may be performed for users other than a searching user or a publishing user. For example, although operation 980 was described as being performed with respect to a searching user, an update also may be provided to other users in the social network (e.g., a user that has expressed similar interests).

Similarly, although some of the operations were described with respect to a searching user, the operations need not be limited to those operations using a web browser to access a search engine. In one configuration, user manipulation of a web page may be monitored and used to derive interests for a user. For example, a host may monitor which content is accessed by a user. Result related to the derived interests then may be presented to the user even though the user may not have specifically engaged a search interface.

Although the sharing of information in personal digital libraries is described with respect to a social networking scheme, other implementations may not require users to belong to a social network in order to share digital assets. For example, a user may indicate a desire to receive information on a particular topic, such as buying a boat. Information related to purchasing a boat, such as, for example, advertisements for boats for sale, boat buyer's guides, or boating safety courses, may exist in another user's digital asset library. Once the user indicates a desire to receive information related to buying a boat, the user seeking the information may automatically receive access to information related to boat buying that exists, or is later created and stored, in the digital library of another. The user seeking the information and the user who has the information need not be currently participating in a social network or be known to, or in contact with, one another in any other way in order for the information to be shared between the users.

Even though in this example the sharing of information may take place outside the social networking context, individual users may still grant or deny access to digital assets in the user's personal digital library in ways similar to those described above. Furthermore, and as also described above, a digital asset may be delivered to a user by placing the digital asset in the user's personal digital library or by delivering the digital asset by email or some other means. In either case, either a full copy of the digital asset or a link to the digital asset may be provided.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, useful results still could be achieved if steps of the disclosed techniques were performed in a different order and/or if components in the disclosed systems were combined in a different manner and/or replaced or supplemented by other components. As another example, a screen name is used throughout to represent a unique identifier of an account, but any other unique identifier of an account may be used when linking accounts. Accordingly, other implementations are within the scope of the following claims.

What is claimed is:

1. A method, performed at least partially on a computer, for establishing a social network, the method comprising:
receiving a search request from a searching user;
accessing a digital asset library of at least one publishing user;
determining a relationship between the search request and the digital asset library of the at least one publishing user;
determining a social networking establishment metric based on the relationship; and
comparing the social networking establishment metric to an establishment threshold and when the social networking establishment metric satisfies the establishment threshold, establishing a social network.

2. The method of claim 1 further comprising after establishing the social network:
reviewing an update to the digital asset library of the publishing user; and
when the update is responsive to a predicted interest of the searching user, enabling the searching user to access the update.

3. The method of claim 1 wherein establishing the social network includes enabling access by the searching user to digital assets located within the digital asset library of the publishing user.

4. The method of claim 3 wherein:
the searching user has a digital asset library, and enabling access by the searching user to the digital assets located within the digital asset library of the publishing user includes providing, in the digital asset library of the searching user, a link to the digital assets located within the digital asset library of the publishing user or a copy of the digital assets of the publishing user.

5. The method of claim 3 further comprising receiving an indication of the publishing user's identity based on a determination made by the publishing user, wherein the indication of the publishing user's identity includes one of the publishing user's identity, an alter ego identity of the publishing user, or an indication that the publishing user's identity is blocked.

6. The method of claim 5 wherein the indication of the publishing user's identity is received in response to the searching user's identity, wherein the searching user's identity is one of a person directly known to the publishing user, a person indirectly known to the publishing user, a subscriber to an online service provider, a member of an organization, or a member of an age group.

7. The method of claim 5 wherein the indication of the publishing user's identity is received in response to a grant by the publishing user of permission to indicate the publishing user's identity.

8. The method of claim 3 wherein enabling access by the searching user to digital assets located within the digital asset library of the publishing user includes:
sharing the digital assets and updates to the digital assets in the digital asset library of the publishing user between the searching user and the publishing user, and enabling access to at least one of the digital assets, or updates to the digital assets, if an indication of a number of digital assets is supported by a social network messaging threshold that indicates a maximum number of digital assets that may be shared during a period of time.

9. The method of claim 1 wherein determining a relationship between the search request and the digital asset library of the publishing user includes determining if the digital asset library of the publishing user includes digital assets having content responsive to the search request.

10. The method of claim 9 further comprising determining if the digital asset having content responsive to the search request is available for access by the searching user based on a permission level provided by the publishing user.

11. The method of claim 1 wherein receiving the search request includes receiving a search request for digital assets from a type of publishing user.

12. The method of claim 1 wherein determining a social networking establishment metric includes determining a number of publishing users that have digital assets having content responsive to the search request.

13. The method of claim 1 wherein comparing the social networking establishment metric to the establishment threshold includes establishing the social network with a threshold number of users.

14. The method of claim 1 where the social networking establishment metric includes a first establishment metric, and the method further comprises:
adjusting the search request in response to determining that the first establishment metric does not support establishing the social network;
determining a relationship between the adjusted search request and the previously accessed digital asset library of the publishing user, and determining a second establishment metric based on the relationship; and
comparing the second establishment metric to the establishment threshold and, when the second establishment metric satisfies the establishment threshold, establishing the social network.

15. The method of claim 14 wherein:
determining that the first establishment metric does not support establishing the social network includes indicating that the first establishment metric is greater than, or is less than, the establishment threshold, and
determining that the second establishment metric satisfies the establishment threshold includes determining that the second establishment metric differs from the establishment threshold by an acceptable amount.

16. The method of claim 14 wherein adjusting the search request includes one of narrowing or broadening a scope of the search request.

17. The method of claim 14 wherein adjusting the search request includes adjusting at least one of an amount of metadata or a type of metadata associated with the search request, wherein the metadata relates the search request to the digital asset library of the at least one publishing user.

18. The method of claim 14 wherein adjusting the search request includes adjusting which digital asset libraries of multiple publishing users are compared with the search request based on types associated with the multiple publishing users.

19. The method of claim 18 wherein the types associated with at least one of the multiple publishing users includes one of a super-publishing user or an under-publishing user, wherein:
the super-publishing user comprises a publishing user who publishes a high quantity of high quality digital assets during a period of time, and the under-publishing user comprises a publishing user who publishes a low quantity of low quality digital assets during the period of time.

20. The method of claim 1 wherein:
the social networking establishment metric indicates a number of users having digital asset libraries that includes digital assets having content responsive to the search result,
the establishment threshold indicates a threshold amount of users that are appropriate to establish a social network, and
the social networking establishment metric satisfies the establishment threshold when the number of users having digital asset libraries that include digital assets having content responsive to the search result is not more than an acceptable amount above or below the threshold amount of users that are appropriate to establish a social network.

21. A method, performed at least partially on a computer, for managing a volume of messages in a first social network created for sharing access to digital assets among users, the method comprising:
determining a social networking messaging metric;
adjusting the social networking messaging metric to support an amount of updates to the digital assets shared in the social network during a period of time; comparing the social networking messaging metric to a messaging threshold and, when the social networking messaging metric does not satisfy the messaging threshold, creating a second social network for sharing access to digital assets and updates to the digital assets.

22. The method of claim 21 wherein creating the second social network includes moving users from the first social network to the second social network such that the second social network includes a number of users and a number of digital assets and updates to the digital assets that is similar to the number of users, digital assets and updates to the digital assets that remain in the first social network.

23. The method of claim 21 wherein creating the second social network includes moving users from the first social network to the second social network such that the second social network includes a quality of users and a quality of digital assets and updates to the digital assets that is similar to the quality of the users, digital assets and updates to the digital assets that remain in the first social network.

24. The method of claim 23 wherein the quality of a user relates to at least one of the quantity of digital assets and updates to the digital assets published by the user and the quality of the content of the digital assets and updates to the digital assets published by the user.

25. The method of claim 23 wherein the quality of a digital asset and an update to a digital asset relates to a responsiveness of the content of the digital asset and update to the digital asset to one or more topics of the social network.
